(19) United States
(12) Patent Application Publication
(10) Pub. No.: US 2015/0267085 A1
(43) Pub. Date: Sep. 24, 2015

(54) HEAVY-RELEASE FORCE RELEASE FILM HAVING SURFACE MICROVISCOSITY AND PREPARATION METHOD THEREOF

(71) Applicant: SHENZHEN MOMA TECHNOLOGY CO., LTD., Shenzhen, Guangdong (CN)

(72) Inventors: Xinyue Xia, Shenzhen (CN); Zhongfei Xi, Shenzhen (CN); Aiwen Ge, Shenzhen (CN); Yong Ye, Shenzhen (CN); Shoucheng Yang, Shenzhen (CN); Xingyang Hua, Shenzhen (CN); Yunyao Zhou, Shenzhen (CN)

(21) Appl. No.: 14/416,638

(22) PCT Filed: Jun. 27, 2013
(86) PCT No.: PCT/CN2013/078100

§ 371 Date: Jan. 23, 2015

(30) Foreign Application Priority Data
Aug. 3, 2012 (CN) 201210275191.3

(51) Int. Cl. C09J 7/02; B05D 3/00

(52) U.S. Cl. CPC C09J 7/0228; B05D 3/007; B05D 3/002; C09J 201/00

(57) ABSTRACT

Disclosed is a heavy-release force release film having surface microviscosity and a preparation method thereof A release layer of the release film comprises: by mass, 10 to 25 parts of vinyl silicone oil, 0.5 to 5 parts of a cross-linking agent, 15 to 40 parts of silicon resin, 25 to 60 parts of a pressure-sensitive adhesive, 1 to 6 parts of a curing agent, and 30 to 60 parts of a diluent. The preparation method comprises: removing water, static electricity, dust and foreign matters on a surface of a substrate; uniformly stirring vinyl silicone oil, the cross-linking agent, the pressure-sensitive adhesive, silicon resin and the diluent according to the above mass part ratio; adding the curing agent into the mixture and stirring; coating the release agent on a processed surface of the substrate, drying and carrying out rolling-up.

### FIELD OF THE INVENTION

The present invention relates to preparation technique of release materials and, in particular, it concerns a heavy-release force release film having surface microviscosity and a preparation method thereof

### BACKGROUND OF THE INVENTION

Release film is also called anti-adhesion film or release liner, which is a product made of a substrate such as polyethylene terephthalate (PET), biaxially oriented polypropylene film (BOPP), polyethylene (PE), polycarbonate (PC), polystyrene (PS), polypropylene (CPP) with low surface energy and adjustable release force. The release film has characteristics of flat surface, high-level of cleanliness, steady size for further process, adjustable transparency and color, wide range of choices of the thickness of the film and the types of the substrate. Due to the above characteristics, the release film may be applied in the photology and electronic field for the development of deep processing of the components and parts thereof, thereby meeting the requirements of more and more automatic production of these fields.

The release film is finally required to achieve a stable release force (force value detected at an angle of 180° and at a speed of 300 mm/min) on the premise that the physical property of carrier film can meet the need thereof When the release film is compounded with the surface of molten solid fusing glue and the thermosetting adhesive which is mainly applied on flexible printed circuit board (FPC), flexible copper clad laminate (FCCL) or prepreg, the release film is needed to have surface microviscosity and release force more than 300 g/inch. The heavy release force can make the glue fully adhere to the surface of the release film and the microviscosity can make the force for stripping not so heavy.

For a traditional release film, its release force is adjusted only by means of adding silicon resin which is taken as conditioning agent, however, the silicon resin and the main materials cannot produce a cross-linking reaction so that the release force is very unstable in a stored procedure, additionally, the silicon resin cannot be compounded with the surface of special glue.

### SUMMARY OF THE INVENTION

In view of the above problems, there are provided a heavy-release force release film having surface microviscosity and a preparation method thereof.

There are provided following technical solutions:

There is provided a heavy-release force release film having surface microviscosity, including a release layer and a substrate. The substrate is one of PET, BOPP, PE, PC, PS and CPP, and the release layer comprises following components by mass: 10 to 25 parts of vinyl silicone oil, 0.5 to 5 parts of a cross-linking agent, 15 to 40 parts of silicon resin, 25 to 60 parts of a pressure-sensitive adhesive, 1 to 6 parts of a curing agent, and 30 to 60 parts of a diluent. The cross-linking agent is hydrogenous silicone oil, the silicon resin is vinyl MQ silicon resin, the pressure-sensitive adhesive is silicone pressure-sensitive adhesive made by means of addition reaction with platinum as catalysts or silicone modified acrylic pressure-sensitive adhesive, and the curing agent is platinum. Specifically, the substrate is processed by a corona process, and has a thickness of 12 um to 250 um and a width of 200 mm to 1500 mm. The vinyl silicone oil has a viscosity range of 4500 cps to 20000 cps, the pressure-sensitive adhesive has a viscosity range of 15000 cps to 50000 cps, and the silicon resin has a viscosity range of 200 cps to 1500 cps.

Preferably, the release film comprises following components by mass: 10 to 25 parts of vinyl silicone oil, 1 to 2.5 parts of a cross-linking agent, 15 to 30 parts of silicon resin, 25 to 35 parts of a pressure-sensitive adhesive, 1.5 to 3 parts of a curing agent, and 30 to 60 parts of a diluent.

In view of the heavy-release force release film having surface microviscosity of the present invention, there is further provided a preparation method of the above-mentioned release film.

The preparation method includes following steps:

(1) removing water, static electricity, dust and foreign matters on a surface of the substrate;

(2) uniformly stirring the vinyl silicone oil, the cross-linking agent, the silicon resin, the pressure-sensitive adhesive and the diluent according to the above mass part ratio, and then adding the curing agent thereinto and stirring it; and

(3) coating a release agent on the surface of the substrate which has been processed according to step (1) and then drying it at a temperature of 60 to 170° C.

Preferably, in the step (1), the water on the surface is removed by means of hot wind, the static electricity is removed by means of an ionizer gun and the dust and foreign matters are removed by means of a silicone roller. In the step (2), a stirring process is carried out by means of a central dispersible plate at a speed of 800 rpm for 30 minutes, and after adding the curing agent, a further stirring process is carried out for 10 minutes. In the step (3), the step of coating a release agent means that: firstly coating a ground coat on the substrate and then precuring it; coating a release layer on the ground coat and then curing it, the step of coating a release layer being carried out; and then rolling it up after drying it by means of an oven.

The release film of the present invention has heavy release force and surface microviscosity, which facilitate the surface adhesion of the unmelted fusing glue, the glue of stiffening plate of flexible printed circuit board (FPC) and the glue of flexible copper clad laminate (FCCL). The preparation method of the above-mentioned release film has advantages of simple process, easy to operate and cost saving.

### DETAILED DESCRIPTION OF ILLUSTRATED EMBODIMENTS

For better understanding the technical content of the present invention, some specific embodiments are provided to introduce and illustrate the technical solution of the present invention as follows.

According to an embodiment of the present invention, disclosed is a heavy-release force release film having surface microviscosity and a preparation method thereof The method for preparing the release film includes three steps as follows:

Step one: firstly, removing the water on a surface of a substrate by means of hot wind, removing the static electricity on the surface of the substrate by means of an ionizer gun and removing the dust and foreign matters on the surface of the substrate by means of a silicone roller.

Step two is a preparation of release agents.

Firstly, prepare the following materials by mass: 17 parts of vinyl silicone oil, 2 parts of a cross-linking agent, 33 parts of silicon resin, 46 parts of a pressure-sensitive adhesive, 2 parts of a curing agent, and right amount of a diluent.

The cross-linking agent is hydrogenous silicone oil with a viscosity of 200 cps; the silicon resin has a viscosity of 500 cps; the pressure-sensitive adhesive is silicone pressure-sensitive adhesive made by means of addition reaction with platinum as catalysts and its viscosity is 3000 cps; and the curing agent is platinum.

Firstly, fully stir the vinyl silicone oil, the cross-linking agent, the silicon resin, the pressure-sensitive adhesive and the diluent, according to above mass part ratio, by means of a central dispersible plate at a speed of 800 rpm for 30 minutes, and then add the curing agent thereinto and stir it at the same speed for 10 minutes.

Step three is to coat a release agent, including the operations of: firstly coating a ground coat on the surface of the substrate which has been processed in the step one and then precuring it; coating a release layer on the ground coat and then curing it; and then rolling it up after drying it by means of an oven so that a finished release film is achieved.

According to the second embodiment to the fifth embodiment, the preparation method of the release film includes the same steps as that of the first embodiment, but the components contained in the release film are provided with different mass part ratio as follows:

TABLE 1

| | The Second | The Third | The Fourth | The Fifth |
|---|---|---|---|---|
| | Embodiment | Embodiment | Embodiment | Embodiment |
| Vinyl Silicone | 23 | 20 | 14 | 14 |
| Oil | | | | |
| Cross-linking | 2.8 | 2.8 | 1.8 | 1.5 |
| Agent | | | | |
| Silicon Resin | 44 | 40 | 28 | 26 |
| Pressure- | 28 | 35 | 53 | 58 |
| sensitive | | | | |
| Adhesive | | | | |
| Curing Agent | 2.2 | 2.2 | 2.2 | 2.5 |
| Diluent | Right | Right | Right | Right |
| | Amount | Amount | Amount | Amount |

The following table shows the test results of the release forces of five release films according to the first embodiment to the fifth embodiment.

TABLE 2

| | Release Force | Release Force | | |
|---|---|---|---|---|
| | Under a | Under a | Residual | Surface |
| | Room | Temperature | Adhesive | Microvis- |
| | Temperature | of 70° C. | Rate | cosity |
| Test Results | g/inch | g/inch | % | g/inch |
| The First | 400 | 445 | 88 | 1 |
| Embodiment | | | | |
| The Second | 450 | 470 | 83 | 1 |
| Embodiment | | | | |
| The Third | 500 | 560 | 79 | 2 |
| Embodiment | | | | |
| The Fourth | 590 | 595 | 80 | 2 |
| Embodiment | | | | |
| The Fifth | 661 | 690 | 83 | 3 |
| Embodiment | | | | |

The release forces are detected by means of using TESA7475 standard adhesive tape, at a speed of 300 mm/min and at an angle of 180°.

The above test results show that the release film of the present invention has advantages of heavy release force and surface microviscosity and the preparation method of the above-mentioned release film has advantages of simple process, easy to operate and cost saving.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A heavy-release force release film having surface microviscosity, comprising a release layer and a substrate, wherein the substrate is one of PET, BOPP, PE, PC, PS and CPP, and the release layer comprises following components by mass: 10 to 25 parts of vinyl silicone oil, 0.5 to 5 parts of a cross-linking agent, 15 to 40 parts of silicon resin, 25 to 60 parts of a pressure-sensitive adhesive, 1 to 6 parts of a curing agent, and 30 to 60 parts of a diluent; the cross-linking agent is hydrogenous silicone oil, the silicon resin is vinyl MQ silicon resin, the pressure-sensitive adhesive is silicone pressure-sensitive adhesive made by means of addition reaction with platinum as catalysts or silicone modified acrylic pressure-sensitive adhesive, and the curing agent is platinum.

2. The release film according to claim 1, wherein the substrate is processed by a corona process, and has a thickness of 12 um to 250 um and a width of 200 mm to 1500 mm.

3. (canceled)

4. The release film according to claim 1, wherein the release layer comprises following components by mass: 10 to 25 parts of vinyl silicone oil, 1 to 2.5 parts of a cross-linking agent, 15 to 30 parts of silicon resin, 25 to 35 parts of a pressure-sensitive adhesive, 1.5 to 3 parts of a curing agent, and 30 to 60 parts of a diluent.

5. (canceled)

6. A preparation method of a heavy-release force release film having surface microviscosity, comprising the following steps:
(1) removing water, static electricity, dust and foreign matters on a surface of the substrate;
(2) uniformly stirring the vinyl silicone oil, the cross-linking agent, the silicon resin, the pressure-sensitive adhesive and the diluent according to a mass part ratio claimed in claim 1, and then adding the curing agent thereinto and stirring it to form a release layer; and
(3) coating a ground coat on the surface of the substrate which has been processed in step (1) and then precuring it; coating the release layer on the ground coat and then curing it; and then rolling it up after drying it by means of an oven at a temperature of 60 to 170° C.

7. The preparation method according to claim 6, wherein in the step (1), the water is removed by means of hot wind, the static electricity is removed by means of an ionizer gun and the dust and foreign matters are removed by means of a silicone roller.

8. The preparation method according to claim 6, wherein in the step (2), a stirring process is carried out by means of a central dispersible plate at a speed of 800 rpm for 30 minutes, and after adding the curing agent, a further stirring process is carried out for 10 minutes.

9. (canceled)
